(19) United States
(12) Patent Application Publication
(10) Pub. No.: US 2012/0124394 A1
(43) Pub. Date: May 17, 2012

(54) System and Method for Providing a Virtual Secure Element on a Portable Communication Device

(76) Inventors: David Brudnicki, Duvall, WA (US); Michael Craft, Carlsbad, CA (US); Hans Reisgies, San Jose, CA (US); Andrew Weinstein, San Francisco, CA (US)

(21) Appl. No.: 13/279,147

(22) Filed: Oct. 21, 2011

Related U.S. Application Data
(60) Provisional application No. 61/414,845, filed on Nov. 17, 2010.

(51) Int. Cl. G06F 12/14

(52) U.S. Cl. 713/193

(57) ABSTRACT

A system for providing a virtual secure element on a portable communication device having a secured element. The system comprising memory; a card management module operably associated with the secure element providing an application programming interface to the secure element and controlling writing to and reading from at least a portion of the memory; a virtual encryption key preferably stored within the secured element; and an encryption engine capable of encrypting data before its placed in the memory and decrypting that data using the virtual encryption key.

This application claims priority from U.S. Provisional Patent Application No. 61/414,845, filed on Nov. 17, 2010.

### TECHNICAL FIELD

The present invention relates generally to the use of secure data to complete a wireless transaction, and more particularly to a system and method for providing a virtual secure element to store secure credentials in the main memory of a portable communication device, which is secured against tampering.

### BACKGROUND

Wireless transactions using RFID-based proximity cards are fairly common, place. For instance, many workers use RFID keycards to gain access to their workplace and drivers use RFID passes to pay tolls at highway speeds. RFID, which stands for radio-frequency identification, uses electromagnetic waves to exchange data between a terminal and some object for the purpose of identification. More recently, companies have been trying to use RFIDs to supported by cellular telephones to implement an electronic payment product (i.e. credit and/or debit card). However, basic RFID technology raises a number of security concerns that have prompted modifications of the basic technology. Still, widespread adoption of RFID as a mechanism for electronic payments has been slow.

Near Field Communication (NFC) is another technology that uses electromagnetic waves to exchange data. NFC waves are only transmitted over a short-range (on the order of a few inches) and at high-frequencies. NFC devices are already being used to make payments at point of sale devices. NFC is an open standard (see, e.g. ISO/IEC 18092) specifying modulation schemes, coding, transfer speeds and RF interface. There has been wider adoption of NFC as a communication platform because it provides better security for financial transactions and access control. Other short distance communication protocols are known and may gain acceptance for use in supporting financial transactions and access control.

Many applications have been developed for use in association with portable communications devices. Some of these applications would benefit from having access to electronic funds to facilitate the consumer's consummation of a electronic transactions via those applications, such as the purchase of goods over the Internet. Still other applications have no purpose if they cannot access the secure data subsystem of the portable communication device.

Card issuers are interested in facilitating the option to pay for application usage and ecommerce using their credit/debit card products. Notwithstanding their self-interest in enabling third party applications to access their financial products, the card issuers may have serious security concerns about broad distribution of security protocols. Similarly, the third party developers may not be interested in developing financial product subroutines. Accordingly, there is a need in the industry for an electronic wallet that is accessible by third party programs to facilitate the payment of charges associated with the use of those programs. The application accessible electronic wallet may also be used via direct access by the consumer to the mobile application. Moreover, secure elements are designed to self-destruct if someone tries to improperly access the data stored within or physically tamper with the card. Thus, there is a need for an intermediary to provide safe access for third-party applications to the secure element to minimize the occurrence of inadvertent self-destruction of secure elements.

Accordingly, the present invention seeks to provide one or more solutions to the foregoing problems and related problems as would be understood by those of ordinary skill in the art having the present specification before them. These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### SUMMARY OF THE INVENTION

The present invention involves a virtual secure element on a portable communication device having a secured element. The system comprising memory; a card management module operably associated with the secure element providing an application programming interface to the secure element and controlling writing to and reading from at least a portion of the memory; a virtual encryption key preferably stored within the secured element; and an encryption engine capable of encrypting data before its placed in the memory and decrypting that data using the virtual encryption key. The memory may be located within the portable communication device. There may also be a reserved memory area for swapping data between the secure element and the memory. This reserved memory area may transmit to the NFC Baseband module.

### BRIEF DESCRIPTION OF THE DRAWINGS

For a better understanding of the present disclosure, non-limiting and non-exhaustive embodiments are described in reference to the following drawings. In the drawings, like reference numerals refer to like parts through all the various figures unless, otherwise specified.

FIG. 1a illustrates an end user using a portable communication device to conduct a secure payment transaction at a point of sale;

FIG. 1b illustrates the operable interconnections between the end user's smartphone and various subsystems, including the system management back end;

FIG. 2 is a block diagram illustrating some of the logical blocks within a portable communication device that may be relevant to the present system;

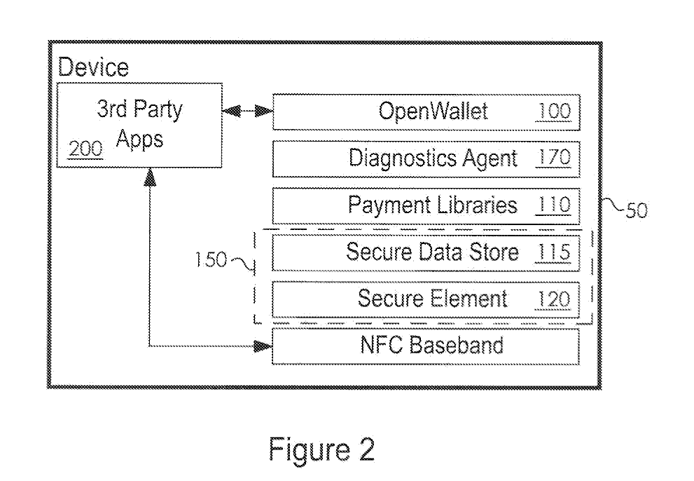

FIG. 3 is a block diagram illustrating one potential embodiment of the virtual secure element within the environment of a portable communication device.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

### Portable Communication Devices

The present invention provides a system and method that can be utilized with a variety of different portable communication devices, including hit not limited to PDA's, cellular phones, smart phones, laptops, tablet computers, and other mobile devices that include cellular voice and data service as well as preferable access to consumer'downloadable applications. One such portable communication device could be an iPhone, Motorola RAZR or DROID; however, the present invention is preferably platform and device independent. For example, the portable communication device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present invention has been generally described in accordance with features and interfaces that are optimized for a smart phone utilizing a generalized platform, although one skilled in the art would understand that all such features and interfaces may also be used and adapted for any other platform and/or device.

The portable communication device includes one or more short proximity electromagnetic communication devices, such as an NFC, RFID, or Bluetooth transceiver. It is presently preferred to use an NFC baseband that is Compliant with NFC IP 1 standards (www.nfcforum.org), which provides standard functions like peer-to-peer data exchange, reader-writer mode (i.e. harvesting of information from RFID tags), and contactless card emulation (per the NFC IP 1 and ISO 14443 standards) when paired with a secure element on the portable communication device and presented in front of a “contactless payment reader” (sec below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device include an NFC/RFID antenna (conformed to NFC IP 1 and ISO 14443 standards) to enable near field communications. However, as would be understood in the art NFC/RFID communications may be accomplished albeit over even shorter ranges and potential read problems.

The portable communication device also includes a mobile network interface to establish and manage wireless communications with a mobile network operator. The mobile network interface uses one more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 WorldWide Interoperability for Microwave Access (WiMax), SIP/RTP, or any of a variety of other wireless communication protocols to communicate with the mobile network of a mobile network operator. Accordingly, the mobile network interface may include as a transceiver, transceiving device, or network interface card (MC). It is contemplated that the mobile network interface and short proximity electromagnetic communication device could share a transceiver or transceiving device, as would be understood in the art by those having the present specification, figures, and claims before them.

The portable communication device further includes a user interface that provides some means for the consumer to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen. As would be understood in the art by those having the present specification, figures, and claims before them, the portable communication device may further include a location transceiver that can determine the physical coordinates of device on the surface of the Earth typically as a function of its latitude, longitude and altitude. This location transceiver preferably uses GPS technology, so it may be referred to herein as a GPS transceiver; however, it should be understood that the location transceiver can additionally (or alternatively) employ other geo-positioning mechanisms, including, but not limited to, triangulation, assisted GPS (ALPS), E-OTD, CI, SAI, ETA, BSS or the like, to determine the physical location of the portable communication device on the surface of the Earth.

The portable communication device will also include a microprocessor and mass memory. The mass memory may include ROM, RAM as well as one or more removable memory cards. The mass memory provides storage for computer readable instructions and other data, including a basic input/output system (“BIOS”) and an operating system for controlling the operation of the portable communication device. The portable communication device will also include a device identification memory dedicated to identify the device, such as a SIM card. As is generally understood, SIM cards contain the unique serial number of the device (ESN), an internationally unique number of the mobile user (IMSI), security authentication and ciphering information, temporary information related to the local network, a list a the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

In the present invention each portable communication device is thought to have two subsystems: (1) a “wireless subsystem” that enables communication and other data applications as has become commonplace with users of cellular telephones today, and (2) the “secure transactional subsystem” which may also be known as the “payment subsystem”. It is contemplated that this secure transactional subsystem will preferably include a Secure Element, similar (if not identical) to that described as part of the Global Platform 2.1.X, 2.2, or 2.2.X (www.globalplatform.org). The secure element has been implemented as a specialized, separate physical memory used for industry common practice of storing payment card-track data used with industry common point of sale; additionally, other secure credentials that can be stored in the secure element include employment badge credentials (enterprise access controls), hotel and other card-based access systems and transit credentials.

### Mobile Network Operator

Each of the portable communications devices is connected to at least one mobile network operator. The mobile network operator generally provides physical infrastructure that supports the wireless communication services, data applications and the secure transactional subsystem via a plurality of cell towers that communicate with a plurality of portable communication devices within each cell tower's associated call. In turn, the cell towers may be in operable communication with the logical network of the mobile network operator, POTS, and the Internet to convey the communications and data within the mobile network operator's own logical network as well as to external networks including those of other mobile network operators. The mobile network operators generally provide support for one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide hand (UWB), IEEE 802.16 Worldwide Interoperability for Microwave Access (WiMax), SIP/RTP, or any of a variety of other wireless communication protocols to communicate with the portable communication devices.

### Retail Subsystem

Standard at merchants today is an Internet Protocol connected payment system that allows for transaction processing of debit, credit, prepay and gift products of banks and merchant service providers. By swiping a magnetic stripe enabled card at the magnetic reader of a Point of Sale Terminal, the card data is transferred to the point of sale equipment and used to confirm funds by the issuing bank. This point of sale equipment has begun to include contactless card readers as accessories that allow for the payment card data to be presented over an RF interlace, in lieu of the magnetic reader. The data is transferred to the reader through the RF interface by the ISO 14443 standard and proprietary payment applications like PayPass and Paywave, which transmit the contactless card data from a card and in the future a mobile device that includes a Payment Subsystem.

A retailer's point of sale device 75 may be connected to a network via a wireless or wired connection. This point of sale network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the point of sale network may utilize any communication method that allows information to travel between the point of sale devices and financial services providers for the purpose of validating, authorizing and ultimately capturing financial transactions at the point of sale for payment via the same financial service providers.

### Secure Transactional Subsystem

The system includes a secure transactional subsystem. The secure transactional subsystem includes the secure element and associated device software for communication to management and provisioning systems as well as the customer facing interface for use and management of secure data stored in the secure element. Preferably the secure transactional subsystem will conform, where appropriate, to an international standard, such as the standard defined in Global Platform 2.1.X or 2.2.

### System Management Back End

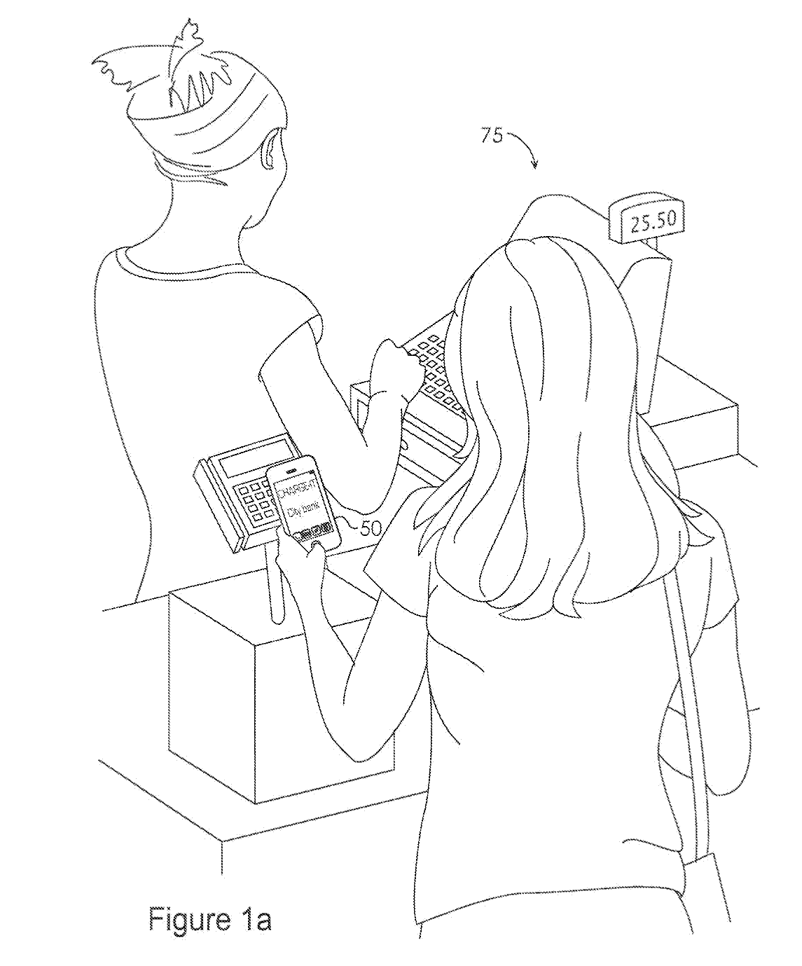

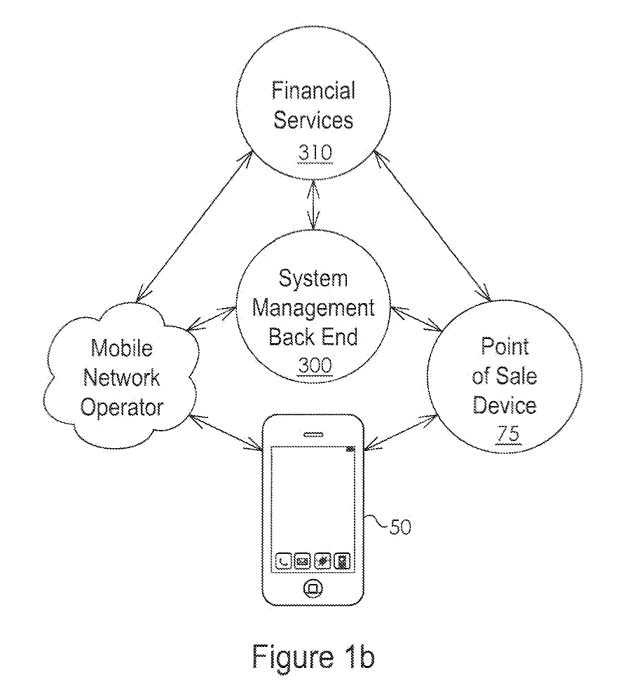

The system includes a system management back end. As shown in FIG. 1b, the system management back end is connected to the retail subsystem, the secure transactional subsystem and to a plurality of portable communication devices via the infrastructure of at least one mobile network operator. The system management back end has a server operably communicating with one or more client devices. The server is also in operable communication with the retailer subsystem, secure transactional subsystem, and one or more portable communication devices. The communications include data and voice channels. Any type of voice channel may be used in association with the present invention, including but not limited to VoIP.

The server may comprise one or more general-purpose computers that implement the procedures and functions needed to run the system back office in serial or in parallel on the same computer or across a local or wide area network distributed on a plurality of computers and may even be located “in the cloud” (subject to the provision of sufficient security). The computer(s) comprising the server may be controlled by Linux, Windows®, Windows CE, Unix, or a Java® based operating system, to name a few. The system management back end server is operably associated with mass memory that stores program code and data. Data may include one or more databases, text, spreadsheet, folder, file, or the like, that may be configured to maintain and store a knowledge base, user identifiers (ESN, IMSI, PIN, telephone number, email/IM address, billing information, or the like).

The system management back end server supports a case management system to provide call traffic connectivity and distribution across the client computers in the customer care center. In a preferred approach using VoIP voice channel connectivity, the case management system is a contact/case management system distributed by Contactual, Inc. of Redwood City, Calif. The Contactual system is a standard CRM system for a VoIP-based customer care call center that also provides flexibility to handle care issues with simultaneous payments and cellular-related care concerns. As would be understood by one of ordinary skill in the art having the present specification, drawings and claims before them other case management systems may be utilized within the present invention such as Salesforce (Salesforce.com, inc. of San Francisco, Calif.) and Novo (Novo Solutions, Inc. of Virginia Beach, Va.).

Each client computer associated with the system management back end server has a network interface device, graphical user interface, and voice communication capabilities that match the voice channel(s) supported by the client care center server, such as VoIP. Each client computer can request status of both the cellular and secure transactional subsystems of a portable communication device. This status may include the contents of the soft memory and core performance of portable communication device, the NFC components: baseband, NFC antenna, secure element status and identification.

### Virtual Secure Element

The developers of third party applications for the more sophisticated of portable communication devices, generally known as smartphones, often want and sometimes even need to present payment data and other credentials via the payment-subsystem. Many of these program developers simply provision the payment data into the standard memory of the portable communication device instead of the “secure element” 120 in the payment subsystem 150 of the portable communication device 50. While current security requirements do not always require such data to be stored in the payment subsystem, providing better security to most credentials is usually desirable. Some the data may only require temporary use of the payment subsystem when the consumer chooses to use services requiring presentation of this data (e.g. coupon data, access control data, event ticket data). Moreover, as use of secured payment subsystems becomes more ubiquitous, the limited size of the secure element 120 will make it difficult to store all of secured payment data that may be desired by consumers.

One or more of these problems may be addressed through the provision of a “virtual” secure element or secure data store 115 maintained outside the traditional secure payment subsystem. The “virtual” secure element or secure data store 115 may be located on any memory accessible to the communication device, including but not limited to, the standard memory 299 on the device, on a removable media (such as a SD card, a CompactFlash card, etc.), on a remote server or computer, in the cloud, etc. This virtual secure element 115 is managed by a card management system maintained in OpenWallet 100. The card management system tracks the issuers of all card, coupon, access control and ticket data stored in the “virtual secure” memory 115 as well as secure element 120 in the payment subsystem 150. For instance, the card management may use the digital signature of a third party application, which uniquely identifies its author for purposes of tracking assets issued by the third party application. In this embodiment, the card management system would reject the attempted storage of data from any unsigned application. The card management system determines which applications are able to view, select and/or change each asset stored in virtual secure memory and prevents unauthorized applications from accessing data stored in virtual secure memory 115 for which they are not authorized. Similarly, the card management system grants temporary access to selected assets in order to securely present data via the contact-less point of sale. Thus, card, coupon, ticket, access control data, and other credentials may be provisioned by the card management system to the virtual secure memory 115 (i.e. outside of the secure element 120) while still utilizing the same mechanisms used to provision data to the “secure element” in the Payment Subsystem.

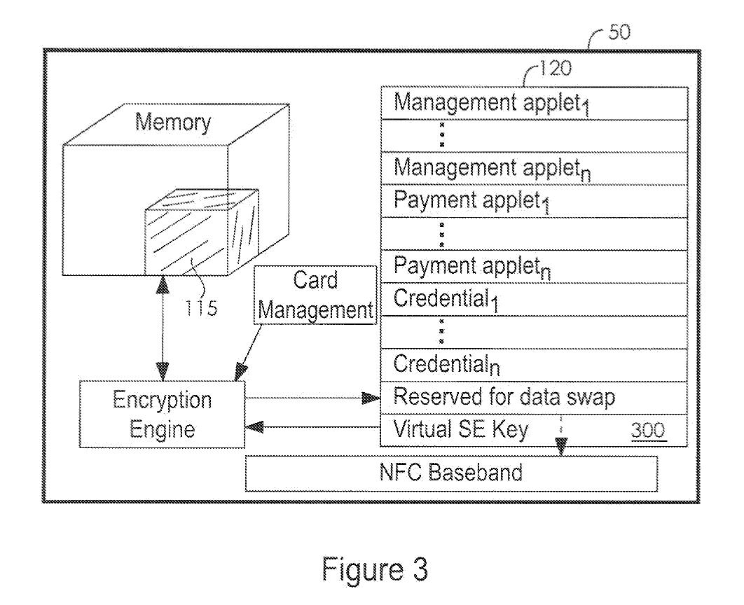

In one embodiment depicted in FIG. 3, the virtual secure element 115 may also be secured using a key 300 or other encryption information that is stored in the secure element 120 of the payment subsystem. In this case, in order to access (i.e. read) data stored within the virtual secure element 115, the card management system 100 would need to access and obtain the key 300 or other encryption information from the secure element 120. This effectively extends the security typically available only within the secure element 120 to the virtual secure element 115. For example, secure elements may be configured to self destruct if multiple improper access attempts are detected. Thus, in this embodiment, if a secure element 120 is disabled due to such improper access attempts, the key 300 or other encryption information would no longer be accessible, effectively rendering the virtual secure element 115 disabled as well.

When an application needs data previously stored in the virtual secure element 115, it requests the data via card management. The encrypted data is located within virtual secure element 115. Because of its encryption using the key 300 stored in the secure element 120, the data is secure when read out of memory. The secure data is fed into the encryption engine along with the virtual SE key 300, so the data can be decrypted. Once decrypted, the data from virtual secure element is saved to a reserved space in the secure element 120. From the reserved space within secure element 120, the decrypted data can be sent to the NFC Baseband for secure presentation to a POS.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although tot explicitly described or shown herein, embody the principles of the invention and, thus, within its scope and spirit.

What is claimed is:

1. A system for providing a virtual secure element on a portable communication device having a secured element, the system comprising:
memory operably associated with the portable communication device;
a card management module operably associated with the portable communication device and with the secure element to provide an application programming interface to the secure element, the card management further capable of controlling writing to and reading from at least a portion of the memory;
a virtual encryption key; and
an encryption engine operably connected between the portion of the memory controlled by the card management module and the secure element, the engine capable of encrypting and decrypting data using the virtual encryption key.

2. The system according to claim 1 wherein the virtual encryption key stored within the secured element.

3. The system according to claim 2 wherein the memory is located within the portable communication device.

4. The system according to claim 3 further comprising a reserved memory area for swapping data between the secure element and the memory.

5. The system according to claim 4 wherein the reserved memory area transmits data to the NFC Baseband module.

6. The system according to claim 1 wherein the memory is located within the portable communication device.

7. The system according to claim 6 further comprising a reserved memory area for swapping data between the secure element and the memory.

8. The system according to claim 7 wherein the reserved memory area transmits data to the NFC Baseband module.
